(19) United States
(12) Patent Application Publication
(10) Pub. No.: US 2021/0346993 A1
(43) Pub. Date: Nov. 11, 2021

(54) METHOD FOR PRODUCING A WELDING WIRE, WELDING WIRE FOR PROCESSING A COMPONENT, AND COMPONENT

(71) Applicant: MTU Aero Engines AG, München (DE)

(72) Inventor: Karl-Hermann Richter, Markt Indersdorf (DE)

(73) Assignee: MTU Aero Engines AG, München (DE)

(21) Appl. No.: 17/054,962

(22) PCT Filed: May 9, 2019
(86) PCT No.: PCT/DE2019/000127

§ 371 Date: Jun. 30, 2021

(30) Foreign Application Priority Data
May 15, 2018 (DE) 10 2018 207 448.8

(51) Int. Cl. B23K 35/40; B22F 7/08; B23K 35/02; B23K 35/30; B23K 35/36

(52) U.S. Cl. CPC B23K 35/406; B22F 7/08; B23K 35/0266; B23K 2103/14; B23K 35/3608; B23K 2035/408; B23K 35/3033

(57) ABSTRACT

The invention relates to a method for producing a welding wire that includes the steps of providing a hollow wire, through at least part of which at least one cavity extends; producing the welding wire by introducing a welding material containing titanium aluminide or at least one nickel-based superalloy into the at least one cavity, the at least one cavity being evacuated or being filled with a protective gas before, during and/or after the introduction of the welding material, and the hollow wire being formed from nickel if the welding material contains the at least one nickel-based superalloy. Further aspects of the invention relate to a welding wire and to a component having at least one component region obtained by hardfacing using at least one such welding wire.

### BACKGROUND OF THE INVENTION

The invention relates to a method for producing a welding wire. Further aspects of the invention relate to a welding wire for processing a component as well as a component.

Known from EP 0 227 634 A1 is a method for producing a weld filler material in the form of a welding wire. In this method, a sheath, which is wound onto a reel, is filled with a metal powder, whereupon the sheath filled with the metal powder is reduced in cross section by drawing, as a result of which any air that is present in the interior of the sheath can escape. For example, the metal powder can be formed from alloys, such as nickel-based alloys or cobalt-based alloys. The tube can be formed from iron, cobalt, and/or nickel, for example.

US 2007/0193228 A1 describes a method for producing a welded metal tube that contains filling elements. In this method, a long narrow metal sheet with two longitudinal edges is supplied and at least a part of the metal sheet is produced in a gutter shape by bringing one of the longitudinal edges close to the other longitudinal edge. The filling elements are subsequently introduced into the gutter and the metal sheet is subsequently produced in the form of a tube by bringing the two longitudinal edges closer to each other until the longitudinal edges are in contact.

Known from EP 2 913 141 A1 is a method for producing a metal-core welding wire. In this method, a seamless tube made of aluminum or an aluminum alloy is formed and this tube is filled with a powder that contains a metal or a metal alloy. The powder made of the metal or the metal alloy is produced from a homogeneous, fused metal or from a metal alloy, which, after solidification, is ground to a predetermined particle size. The powder-filled tube is drawn to a predetermined diameter, whereupon, as a result of the drawing, the powder is compressed in such a way that gas introduced together with the powder is removed completely from the tube.

### SUMMARY OF THE INVENTION

The object of the present invention is to create a method for producing a welding wire, which makes it possible to produce welded connections that are especially capable of withstanding stress by means of hardfacing on a component. Another object of the invention consists in providing a corresponding welding wire as well as a corresponding component.

These objects are achieved in accordance with the invention by a method, by a welding wire, and by a component in accordance with the present invention. Advantageous embodiments with appropriate further developments of the invention are discussed in detail below, whereby advantageous embodiments of each aspect of the invention are to be regarded as advantageous embodiments of each of the other invention aspects.

A first aspect of the invention relates to a method for producing a welding wire, comprising at least the steps:
providing a hollow wire, through a part of which at least one cavity extends;
producing the welding wire by introducing a welding material containing titanium aluminide or containing at least one nickel-based superalloy into the at least one cavity, the at least one cavity being evacuated before, during, and/or after the introduction of the welding material or being filled with protective gas, and then the hollow wire being formed from nickel if the welding material contains the at least one nickel-based superalloy.

It is hereby of advantage that, by way of the evacuation or the filling of the cavity with protective gas, it is possible largely to prevent or at least strongly to diminish the occurrence of any oxidation processes of the welding material that weaken the weld seam when the welding wire is used for welding. In other words, the protective gas or vacuum PROTECTS from oxidation the welding material that has liquefied during welding. Included among the especially suitable protective gases are, for example, argon (Ar) or helium (He). Overall, by way of the protective gas or vacuum, any contamination of the welding material with oxygen can be effectively prevented or at least diminished. The method enables metallic welding wires to be produced from especially strong materials, such as titanium aluminide or the at least one nickel-based superalloy, the production of which by wire drawing or by another shaping method can pose difficulties or even be impossible. Materials of this kind that are difficult to shape, such as titanium aluminide or the at least one nickel-based superalloy, can also exhibit a low tendency to undergo fusion welding; that is, they cannot be deposited at all or can be deposited only with great effort by fusion welding when a component is hardfaced and thus processed in this way. Nickel, in particular pure nickel, exhibits a good tendency to undergo fusion welding, that is, it is suitable for fusion welding. Thus, if the welding material contains the at least one nickel-based superalloy and the hollow wire is made of nickel, in particular pure nickel, the welding wire can be used for fusion welding—for example, for hardfacing—in spite of the low tendency of the at least one nickel-based superalloy to undergo fusion welding. If the welding material contains titanium aluminide (instead of the at least one nickel-based superalloy), then the hollow wire can be formed, for example, from titanium, in particular pure titanium, or from aluminum, in particular pure aluminum. Titanium and aluminum likewise exhibit a good tendency to undergo fusion welding, that is, are suitable for fusion welding. The invention is based on the realization that nickel as well as titanium or aluminum can have a positive influence on process stability during fusion welding, in particular if the hollow wire is formed from nickel or from titanium or aluminum, that is, if, the nickel or else the titanium or the aluminum is not in powder form, but rather is supplied in the form of a wire (as the hollow wire). The improved process stability leads, for example, to a lower porosity of a weld seam that is formed from the welding wire. Thus, by way of a coaxial wire feeding of the welding wire during hardfacing (wire hardfacing), for example, there are very few limitations in the build-up of 3D contours when the component is processed.

The protective gas can be introduced into the cavity before, during, and, additionally or alternatively, after the introduction of the welding material into the cavity. In order to make this possible, the introduction of the welding material can be carried out, for example, in a protective-gas chamber (glove box) or in a vacuum chamber (with a suitable air lock system).

The filling with protective gas or the evacuation before introducing the welding material is of advantage, because any amount of oxygen that is present in the cavity is already reduced at the start of the introduction, so that it is possible from the very beginning to prevent, in an especially effective manner, any inclusion of oxygen-containing gas pores in the welding material introduced into the cavity.

The filling with protective gas or the evacuation during the introduction of the welding material is of advantage, because, in this way, any oxygen that is contained in the welding material that is to be introduced can be expelled at least partially from the cavity during the introduction.

The filling with protective gas or the evacuation after the introduction of the welding material is of advantage, because, in this way, any residual amount of oxygen can be removed from the cavity.

If the cavity is evacuated or charged with protective gas before, during, and, additionally, after the introduction of the welding material, then it is possible to keep the amount of oxygen in the cavity especially low overall.

The welding wire can generally be employed and accordingly used for a high-energy beam welding method, such as, for example, a laser welding method or an electron beam welding method. Besides the mentioned high-energy beam welding method, the welding wire can also be utilized for other possible welding methods, such as, for example, protective gas welding methods or plasma welding methods.

In an advantageous further development of the invention, a further step occurs: sealing of the cavity after the introduction of the welding material into the cavity, as a result of which any flow of fluid between the cavity and the surroundings of the welding wire is prevented. This is of advantage, because, owing to the sealing of the cavity, it is possible to prevent not only any diffusion of oxygen or air in the fluid flow into the cavity and thus into the welding material, but also, in an especially advantageous way, to prevent any penetration of moisture (fluid flow of water) into the cavity.

In another advantageous further development of the invention, the sealing of the cavity takes place by sealing at least one opening of the welding wire that connects the cavity with the surroundings at at least one wire end of the welding wire. This is of advantage, because, owing to the sealing of the opening at the end of the welding wire, any penetration of oxygen or moisture can be prevented even without a separate sealing means, such as, for example, a vacuum film, into which the welding wire can be thermosealed under vacuum (vacuum-sealed). Accordingly, the welding wire can also be transported in unpackaged form, without oxygen or moisture penetrating into the cavity. In this way, it is possible to protect the environment and the welding wire is ready to use in an especially fast manner, particularly since it is not necessary to unpack the welding wire from a packaging (for example, the vacuum film). If need be, the welding wire can afterwards be cleaned as needed, whereby any external contaminants are eliminated.

The opening can be a through opening that can extend as the cavity through the hollow wire or welding wire. Insofar as the opening is formed as a through opening, wire ends of the welding wire that lie opposite each other can be sealed in order to avoid any penetration of oxygen or moisture at welding wire ends that lie opposite each other.

Preferably, the at least one welding wire end can be present under vacuum or under protective gas when the opening is sealed. In this way, it is possible to prevent effectively any penetration of oxygen and moisture into the cavity until the sealing is completed. The opening can generally be sealed by a thermal joining process, such as, for example, a welding method, as a result of which an especially gas-tight sealing of the cavity is made possible. Thus, it is possible, for example, to place a spot weld at the end of the welding wire in order to seal the opening.

In another advantageous further development of the invention, the hollow wire is provided by bending a sheet metal element to create a cavity, with respective edges of the sheet metal element being arranged adjacent to each other and subsequently being joined to each other. In this way, there exists an especially high degree of freedom in shaping during the deformation of the sheet metal element to form the hollow wire. This procedure enables the hollow wire to be formed from the sheet metal element in an especially favorable manner.

The sheet metal element can be supplied as a ribbon material, which can be bent in order to obtain a hollow cylinder shape, for example.

In another advantageous further development of the invention, the edges of the sheet metal element are joined to each other by way of a thermal joining process, in particular a welding method. This is of advantage, because, in this way, the hollow wire is formed as a seamless hollow wire and a common joining region of the sheet metal element edges can be sealed in an especially gastight manner. Any penetration of oxygen or moisture at the edges of the sheet metal element is thereby prevented in an effective manner. The thermal joining process can be, for example, a high-energy beam welding method, such as, for example, a laser beam welding method. Due to the formation as a seamless hollow wire by means of joining the edges of the sheet metal element by use of thermal joining processes, it is possible, in comparison to folding methods of the prior art, in which folded hollow wires are produced, to join the edges of the sheet metal element in an overall especially gastight manner.

In another advantageous further development of the invention, the sheet metal element is placed, at least during the thermal joining process, under vacuum or under a protective gas atmosphere. This is of advantage, because, in this way, an especially high joining quality with low oxygen content can be achieved at a joining region of the edges of the sheet metal element.

During the thermal joining process, it is possible, for example, for a seam welding of sheet metal element edges to take place by way of a high-energy beam (for example, a laser beam), whereby, as a result of the protective gas atmosphere, a local protective-gas shielding of the edges of the sheet metal element that are to be joined to each other can take place by putting them under argon or helium or, by way of a vacuum atmosphere, an evacuation of the sheet metal element edges can take place. Accordingly, the joining of the sheet metal element edges can be carried out, for example, in a protective-gas chamber or in a vacuum chamber.

In another advantageous further development of the invention, the sheet metal element is shaped to form the hollow wire with the creation of a cross section of hollow cylinder shape. In other words, the sheet metal element is shaped in such a way that the hollow wire has a cross section of hollow cylinder shape. This is of advantage, because, owing to the cross section of hollow cylinder shape, in contrast to a cross section of rectangular shape, an especially low-compression rolling up of the welding wire produced from the sheet metal element can take place.

In another advantageous further development of the invention, the welding material is present in a powdered state when it is introduced into the cavity. This is of advantage, because, in this way, the welding material can be introduced with especially low effort. During the introduction, the welding material can be present, for example, as a TiAl powder (titanium aluminide powder).

In another advantageous further development of the invention, the hollow wire is formed from titanium or from aluminum if the welding material contains titanium aluminide. In other words, therefore, titanium or aluminum can be used as a material for the hollow wire if the welding material contains titanium aluminide. Accordingly, the hollow wire can be formed completely and thus exclusively from titanium or aluminum. This is of advantage, because both titanium and aluminum have a low weight with, at the same time, high strength.

In another advantageous further development of the invention, the welding material is formed from titanium aluminide or from the at least one nickel-based superalloy. In other words, therefore, exclusively titanium aluminide or exclusively the at least one nickel-based superalloy can be used as the welding material. Titanium aluminide as well as the at least one nickel-based superalloy are characterized by an especially low weight with, at the same time, high strength.

In another advantageous further development of the invention, the welding material comprises Nb and/or Mo if the welding material contains titanium aluminide. Thus, instead of pure titanium aluminide, it is possible to use, in an advantageous manner, a powder mixture consisting of Ti and Al as well as Nb (niobium) and, additionally or alternatively, Mo (molybdenum) as the welding material, which can be produced with little effort and in a cost-effect manner. In this case, so-called TiAl-TNM can be used as a the welding material. In this way, it is possible to dispense with the production of pure TiAl powder involving much effort and to compensate for any vaporization of the light aluminum (during the production of the welding wire as well as during any thermal joining method) in a simple manner by using beforehand a higher proportion of Al powder for producing the welding wire.

A second aspect of the invention relates to a welding wire for processing a component, in particular for a turbomachine, by means of hardfacing, wherein the welding wire is obtained by a method in accordance with the first aspect of the invention. The processing of the component may involve, for example, a production of the component and/or a repair of the component. The features ensuing thereby and the advantages thereof are to be taken from the descriptions of the first invention aspect (first aspect of the invention), whereby advantageous embodiments of the first aspect of the invention are to be regarded as advantageous embodiments of the second invention aspect (second aspect of the invention) and conversely.

A third aspect of the invention relates to a component, in particular for a turbomachine, comprising at least one component region, which is obtained by hardfacing using at least one welding wire in accordance with the second aspect of the invention. The component region thereby contains at least portions of the welding wire, that is, portions of the hollow wire and of the welding material. The component can be, for example, a component of a turbomachine that is formed, at least in parts or else completely, from titanium aluminide. The component can be, for example, a guide vane ring, a housing part in a compressor or in a turbine, an outlet guide wheel, a stator segment, or a sealing ring, to name just a few examples. Through the use of the welding wire for processing the component, it is possible to form at least the component region that is designed, for example, as a weld seam or a spot weld with especially high quality of the welding region in the component. Through the use of the welding wire in accordance with the second aspect of the invention, the component region has an especially low proportion of oxidation constituents.

The features ensuing thereby and the advantages thereof are to be taken from the descriptions of the first aspect of the invention and the second aspect of the invention, whereby advantageous embodiments of the first and second invention aspects are to be regarded as advantageous embodiments of the third invention aspect (third aspect of the invention) and conversely.

In an advantageous further development of the invention, at least one region of the component that differs from the component region is formed completely from titanium aluminide or completely from the at least one nickel-based superalloy. This imparts to the component an especially high strength with, at the same time, an especially low weight. The region that differs from the component region can be a region that adjoins the component region, which, by way of hardfacing using the welding wire, can be joined to the component region in a material-bonded manner.

### BRIEF DESCRIPTION OF THE DRAWING FIGURES

Further features of the invention ensue from the claims, the figures, and the descriptions of the figures. The features and combinations of features mentioned above in the description as well as the features and combinations of features mentioned below in the descriptions of the figures and/or shown solely in the figures can be used not only in the respectively given combinations, but also in other combinations, without leaving the scope of the invention. Accordingly, the invention is also regarded as comprising and disclosing embodiments that are not shown explicitly and explained in the figures, but can derive from and be produced from the explained embodiments by separate combinations of features. Also to be regarded as disclosed, therefore, are embodiments and combinations of features that thus do not have all features of an originally formulated independent claim.

Shown are:

FIG. 1 a cut-away illustration of a sub-region of a welding wire;

FIG. 2 a side view of the sub-region of the welding wire; and

FIG. 3 a schematic perspective view onto a component of a turbomachine, a component region of the component being formed by hardfacing using the welding wire and regions of the component that differ from the component region being formed completely from titanium aluminide.

### DESCRIPTION OF THE INVENTION

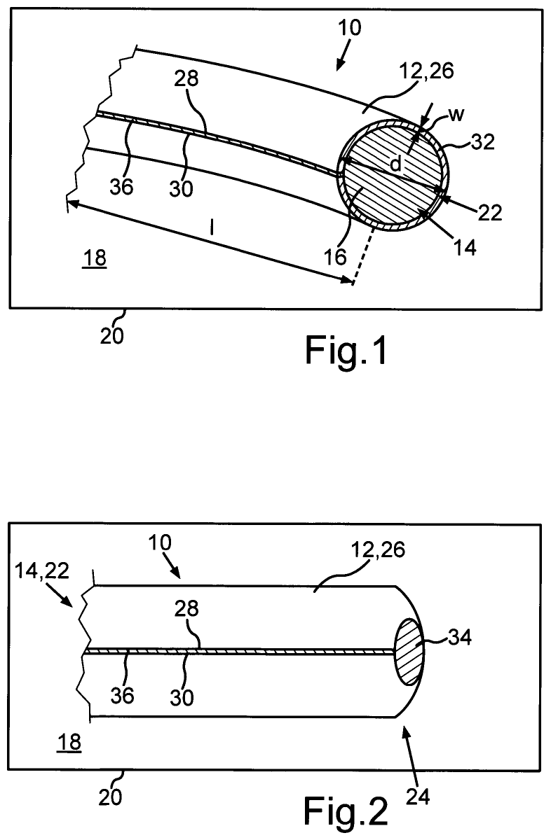

FIG. 1 and FIG. 2 each show method steps for producing a welding wire 10, which, in FIG. 1 and FIG. 2, is shown only in sections in each case.

For the production of the welding wire 10, a hollow wire 12 is initially supplied, through which a cavity 14 extends. The hollow wire 12 is provided by bending a sheet metal element 26, which is formed as a titanium sheet or as a nickel sheet, that is, is formed from pure titanium or pure nickel, with creation of the cavity 14, until the sheet metal element 26 is shaped to form a hollow wire 12 with a cross section of hollow cylinder shape 32, as illustrated in FIG. 1. Each of the edges 28, 30 of the sheet metal element 26 are hereby arranged so as to adjoin each other (see FIG. 1) and are subsequently joined to each other by a thermal joining process in the form of a welding method with the creation of a weld seam 36. In summary, therefore, the hollow wire 12 is completely and thus exclusively formed from titanium or, alternatively to this, exclusively from nickel.

The sheet metal element 26 is placed under a protective gas atmosphere during the thermal joining process. To this end, the sheet metal element 26 is situated in a chamber 20, which in the present example, is filled with argon and/or helium as protective gas 18, thereby creating the protective gas atmosphere. Alternatively to this, the chamber 20 can also be evacuated, so that a vacuum atmosphere can be created in the chamber 20. The production of the welding wire 10 takes place by introducing a welding material 16, comprising a mixture of Ti, Al, Nb, and Mo or, alternatively, formed completely from titanium aluminide or, in one embodiment of the hollow wire 12, from pure nickel or, alternatively to this, from at least one nickel-based superalloy, via an opening 22, which, in the present case, is formed as a through opening, into the cavity 14, the cavity 14 being filled with the protective gas 18 before, during, and after the introduction of the welding material. During its introduction into the cavity 14, the welding material 16 is present in a powdered state. In other words, during its introduction into the cavity 14, the welding material 16 exists as a TiAl powder or as a nickel-based superalloy powder.

Both the protective gas atmosphere, which fills the cavity 14 with the protective gas 18, as well as the vacuum atmosphere have an oxygen fraction inside cavity 14, during as well as after the introduction, that can be kept at a reduced level in comparison to the surrounding air. In this way, it is possible to prevent, at least in large part, undesired oxidation processes when the welding wire 10 is later used for hardfacing.

After introduction of the welding material 16 into the cavity 14, the cavity 14 is sealed, as a result of which any flow of fluid between the cavity 14 and the surroundings of the welding wire 10 is prevented. At the latest, after the cavity is sealed, the protective gas atmosphere can be removed and thus exposure to the protective gas 18 can be ended. The cavity 14 is sealed by sealing the particular openings that connect the cavity 14 to the surroundings and lie opposite to each other at respective ends of the welding wire 10, with FIG. 2 showing, by way of example, only one of the openings, namely, an opening 22 of the welding wire 10 at one of the welding wire ends, namely, at a welding wire end 24 of the welding wire 10. In the present variant, the opening 22 at the folded welding wire end 24, for example, is sealed by a spot weld 34.

The welding wire 10 that is produced by the described method can be used for processing a component 50 of a turbomachine, for example, by means of hardfacing. The processing can involve the production or repair of the component 50.

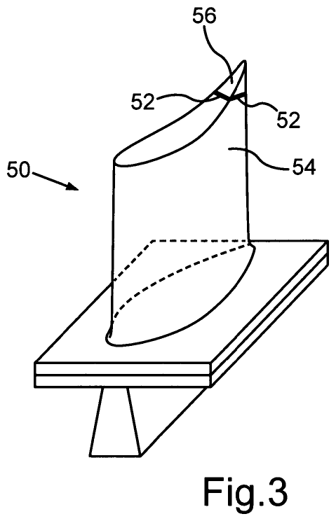

FIG. 3 shows the component 50 for the turbomachine, which is not illustrated in more detail. In the present variant, the component 50 is designed as a blade. The component 50 comprises a component region 52 in the form of a weld seam, which is obtained by hardfacing using the welding wire 10. In the present case, each of the regions 54, 56 of the component 50, which differ from the component region 52, are formed from the titanium aluminide Ti-48Al-2Cr-2Nb. The regions 54, 56 each represent sub-segements (here, blade segments) of the component 50, which are joined to each other in a material-bonded manner via the component region 52 by hardfacing using the welding wire 10. Thus, for example, it is possible to join the region 56 to the region 54 in the course of a repair by the weld seam (component region 52). In order to avoid any crack formation due to the hardfacing, it may be appropriate to preheat the regions 54, 56 at least at a common joining zone at which the joining of the regions 54, 56 is to occur via the component region 52, to a temperature of 750-800° C., for example.

The welding wire 10, which may also be referred to as a filler wire, offers the advantage that the chemical composition of the welding material 16 (here, TiAl powder) can be chosen in such a way that the component region 52 that is formed by hardfacing can correspond to the desired value of a corresponding chemical composition of the respective regions 54, 56, which are likewise formed from TiAl. In this case, a wall thickness of the hollow wire 12 and thus a fraction of pure titanium can be taken into consideration in the component region 52 (here, the weld seam of the component 50). During hardfacing using the welding wire 10, a melt that is formed from the hollow wire 12 and the welding material 16 can likewise correspond to the composition of the respective regions 54, 56, so that the melt can accordingly have the composition Ti-48Al-2Cr-2Nb. In this way, when the regions 54, 56 are joined to the component region 52, the result is an especially homogeneous material structure that can withstand stress.

Through the use of the welding wire 10 (filler wire) during hardfacing by means of a high-energy beam (laser beam or electron beam), it is possible to prevent any absorption of moisture (entry of moisture into the cavity 14) as well as also any contaminants of the welding material 16 or of the component region 52 in an effective manner. The described method makes possible a reproducible production of the welding wire 10, as a result of which reproducible welding characteristics with, at the same time, high welding quality can be achieved. The described method makes it possible to supply especially brittle titanium aluminide (TiAl) in the cavity 14 of the welding wire 10 as a welding additive.

The welding wire 10 can also generally be used for the additive manufacture of the component 50, that is, in other words, for layer-by-layer buildup of the component 50, although, in the present case, this is not shown further. Furthermore, the production of hybrid TiAl components is possible by way of hardfacing using the welding wire 10.

The invention is based on the general knowledge that welding wires that are formed from titanium aluminide or from the at least one nickel-based superalloy cannot be produced by a conventional drawing process, especially since titanium aluminide or nickel-based superalloys are too brittle for drawing processes of this kind.

A further advantage consists in the fact that the welding wire 10 can be preheated to a very high temperature prior to the welding method (fusion welding or hardfacing), so that it is possible to dispense with a local preheating of the component 50 in order to avoid welding cracks. The welding method with a preheated welding wire 10 may also be referred to as hot-wire welding. By preheating of the welding wire 10, it is possible, for example, to reduce the power of a welding current source used for the welding method. Hot-wire welding can be carried out with an especially smaller input of heat into the component 50 and does not lead at all, or only to a small extent, to thermal distortion of the component 50.

In summary, the present method describes the production of the welding wire 10, which can be used as a filler wire in hardfacing (wire hardfacing), wherein the hollow wire 12 can form a cylindrical sheath from pure titanium or pure nickel with a predetermined wall thickness w (see FIG. 1) and wherein the welding material 16 can be formed from pure, powdered TiAl (TiAl powder) or from the at least one, pure, powdered nickel-based superalloy. The powdered TiAl or the at least one powdered nickel-based superalloy may also be referred to below simply as a powder or powder batch.

During introduction, the welding material 16 can, for example, be present as a powder batch, the chemical composition of which, under the assumption that the wall thickness w of the hollow wire 12, which is referred to below as a sheath, is formed from pure titanium or from pure nickel, and can be calculated as shown below by way of example. Respective weight proportions of the welding wire 10 can be identical to the weight proportions of the welding material 16, which is also referred to below as base material G.

Respective dimensions of the hollow wire 12 in FIG. 1 are here defined as:

d: diameter of the hollow wire 12 (see FIG. 1)
w: wall thickness of the hollow wire 12 (see FIG. 1)
l: length of a regarded wire segment of the hollow wire 12 (see FIG. 1)
Furthermore, the following applies:
F_{P}: cross-sectional area of the introduced powder
F_{H}: annular cross-sectional area of the filler wire
m_{H}: mass of the sheath with the length l
M_{P,H}: mass of the powder H made of the element of the sheath in the filler wire of length l
mᵢ: mass of the powder i made of element i of the filler wire of length l
ρ_{H}: density of the material of the sheath
ρ′_{H}: bulk density of the powder made of the element in the sheath in the filler wire
ρ′ᵢ: bulk density of the powder i made of element i in the filler wire
g_{H}: nominal weight proportion of the element H in the base material G
gᵢ: nominal weight proportion of the element i in the base material G
g′_{H}: nominal weight proportion of the element H in the filler wire
g′ᵢ: nominal weight proportion of the element i in the filler wire

The chemical composition of the powdered welding material 16 can be calculated under the above-mentioned assumption (sheath formed from pure titanium or pure aluminum or formed from pure nickel) with reference to FIG. 1, where the welding material 16 (base material) may also be referred to as material G:

$$\begin{matrix}{F}_{P} = \frac{π}{4} \times {( d - w )}^{2} & ( 1 ) \\ {F}_{H} = \frac{π}{4} \times ( 2 \times d - w ) & ( 2 ) \\ {m}_{H} = {F}_{H} \times l \times {ρ}_{H} & ( 3 ) \\ {m}_{P , H} = {F}_{P} \times l \times {{ρ}^{′}}_{H} \times {{g}^{′}}_{H} & ( 4 ) \\ {m}_{P , i} = {F}_{P} \times l \times {{ρ}^{′}}_{i} with i = 2 , 3 , … n & ( 5 ) \\ ϵ = {F}_{H} / {F}_{P} & ( 6 ) \\ {g}_{H} = \frac{{ρ}_{H} \times ϵ + {{ρ}^{′}}_{H} \times {{g}^{′}}_{H}}{{ρ}_{H} \times {{ϵρ}^{′}}_{H} \times {{g}^{′}}_{H} + {\sum }_{i = 2}^{n} {{ρ}^{′}}_{i} \times {{g}^{′}}_{i}} & ( 7 ) \\ {g}_{i} = \frac{{ρ}_{i} \times {{g}^{′}}_{i}}{{ρ}_{H} \times {{ϵρ}^{′}}_{H} \times {{g}^{′}}_{H} + {\sum }_{i = 2}^{n} {{ρ}^{′}}_{i} \times {{g}^{′}}_{i}} i = 2 , 3 , … n & ( 8 )\end{matrix}$$

Overall, the filler wire has the weight proportions g of the material G (welding material 16; titanium aluminide or nickel-based superalloy). This results in n linear equations (7) and (8), with which the nominal weight proportions g′ of all n elements of the welding wire 10 can be calculated in a simple manner.

The chemical composition of the welding material 16, which corresponds to a filling of the welding wire 10, can be adjusted in such a way that, after the welding method (wire hardfacing), the additively built-up component region 52 has a chemical composition that corresponds to the chemical composition of the titanium aluminide or to the chemical composition of the at least one nickel-based superalloy. In this way, it is possible to take into consideration beforehand and address any process-related vaporization of aluminum fractions during the welding method.

By use of the present method, it is possible for a filling of the hollow wire 12 with titanium aluminide or with the at least one nickel-based superalloy to take place as needed in the form of one nickel-based casting material or a plurality of nickel-based casting materials. In the latter case, the hollow wire 12 (outer sheath of the welding wire 10) is formed from pure nickel, whereas the welding material 16 (filling) is adjusted in such a way that the entire welding wire 10 corresponds to the composition of the nickel-based superalloy (or nickel-based casting alloy). If need be, it is also possible to compensate here for the vaporization of lighter alloy elements by increasing the weight proportion of these light alloy elements in the welding wire 10 beforehand, as has already been described for the process-related vaporization of the above-mentioned aluminum fractions.

The above-described nickel-based casting materials can be utilized, in particular, as blade materials in the field of a turbine of an aircraft engine and in stationary gas turbines. Typical representatives of the nickel-based casting materials are polycrystalline materials, such as, for example, INCONEL 100, INCONEL 713, or MAR-M 247 as well as monocrystalline materials, such as, for example, Rene N5, PW1484, or LEK94. These polycrystalline or monocrystalline materials are especially suitable as welding material 16 of the welding wire 10.

In order to avoid any crack formation in the region of the component region 52 that is formed by the welding method, the component 50 and, additionally or alternatively, the welding wire 10 can be heated locally to a temperature of greater than 1000° C., for example. Such a local heating of the welding wire 10 nearly to its melting temperature may also be referred to as hot-wire welding (hot-wire hardfacing). The possibility of a preheating of this kind in order to avoid crack formation represents a special advantage of the welding wire 10 in comparison to a purely powdered welding additive.

Regions that are strongly heated during the welding method and thus are hot, such as, for example, the component region 52 either can be shielded locally by the protective gas 18 or else, in an especially advantageous manner, can be placed under the protective gas 18 or under vacuum in the chamber 20.

In order to prevent any contamination of the welding material 16, the introduction of the welding material 16 can take place under the protective gas atmosphere (the atmosphere formed by the protective gas 18). In order to avoid the penetration of moisture, the welding wire ends can be sealed by the respective spot weld 34.

The welding wire 10 filled with the nickel-based superalloy as a welding material 16 is especially suitable for the repair of damaged components, such as explained on the basis of the component 50. Independently of this, the welding method using the welding wire 10 can also be employed for the production of welded constructions.

In addition to the hardfacing, the welding wire 10 can also be employed as an additive material for joint welding of welded constructions that are similar in kind or hybrid.

1. A method for producing a welding wire, comprising the steps of:
providing a hollow wire, through at least part of which at least one cavity extends;
producing the welding wire by introducing a welding material containing titanium aluminide or at least one nickel-based superalloy into the at least one cavity, wherein the at least one cavity is evacuated before, during, and/or after the introduction of the welding material or is filled with a protective gas, and wherein, if the welding material contains the at least one nickel-based superalloy, the hollow wire is formed from nickel.

2. The method according to claim 1, further further comprising the step of:
sealing of the cavity after the introduction of the welding material into the cavity, as a result of which any flow of fluid between the cavity and the surroundings of the welding wire is prevented.

3. The method according to claim 2, wherein the sealing of the cavity takes place by sealing at least one opening of the welding wire that connects the cavity with the surroundings at at least one welding wire end of the welding wire.

4. The method according to claim 1, wherein the hollow wire is provided by bending a sheet metal element with the creation of the cavity, wherein respective sheet metal element edges of the sheet metal element are arranged so as to adjoin each other and are subsequently joined to each other.

5. The method according to claim 4, wherein the sheet metal element edges are joined to each other by a thermal joining process, in particular a welding method.

6. The method according to claim 5, wherein the sheet metal element is placed under a vacuum atmosphere or under a protective gas atmosphere, at least during the thermal joining process.

7. The method according to claim 4, wherein the sheet metal element is shaped to form the hollow wire with the creation of a cross section of hollow cylinder shape.

8. The method according to claim 1, wherein the welding material is present in a powdered state when it is introduced into the cavity.

9. The method according to claim 1, wherein the hollow wire is formed from titanium or from aluminum if the welding material contains titanium aluminide.

10. The method according to claim 1, wherein the welding material is formed from titanium aluminide or from the at least one nickel-based superalloy.

11. The method according to claim 1, wherein the welding material contains Nb and/or Mo if the welding material contains titanium aluminide.

12. The method according to claim 1, wherein a welding wire for processing a component for a turbomachine, by hardfacing, is provided.

13. The method according to claim 1, wherein a component for a turbomachine including at least one component region, which is obtained by hardfacing using at least one welding wire, is provided.

14. The method according to claim 13, wherein at least one region of the component that differs from the component region is formed completely from titanium aluminide or completely from the at least one nick-based superalloy.
